(19) United States
(12) Patent Application Publication
(10) Pub. No.: US 2015/0131262 A1
(43) Pub. Date: May 14, 2015

(54) ELECTRONIC APPARATUS FOR HOSE ATTACHMENT TO ENHANCE VISIBILITY AND SAFETY AND METHOD THEREFOR

(71) Applicant: ALL CLEAR FIRE SYSTEMS, LLC, PHOENIX, AZ (US)

(72) Inventors: JAMES A. MABRY, JR., PHOENIX, AZ (US); DANNY KLEITSCH, PHOENIX, AZ (US); THOMAS SMITH, PHOENIX, AZ (US)

(73) Assignee: ALL CLEAR FIRE SYSTEMS, LLC, PHOENIX, AZ (US)

(21) Appl. No.: 14/195,649

(22) Filed: Mar. 3, 2014

Related U.S. Application Data
(63) Continuation of application No. 14/079,837, filed on Nov. 14, 2013.

(51) Int. Cl. H04N 7/18; F21V 23/04; F21V 31/00

(52) U.S. Cl. CPC H04N 7/18; F21V 31/00; F21V 23/0457
USPC 362/96

(57) ABSTRACT

An illumination device for attachment to a hose has a housing coupled to the hose. The housing allows a substance from the hose to flow through the housing. An electronic circuit is stored in an interior of the housing to illuminate an area in front of the hose and to transmit data to and from the illumination device.

### RELATED APPLICATIONS

The present application is a Continuation of U.S. patent application entitled “ELECTRONIC APPARATUS FOR HOSE ATTACHMENT TO ENHANCE VISIBILITY AND SAFETY AND METHOD THEREFOR”, Filed Nov. 14, 2013, and having U.S. Ser. No. 14/079,837 and in the names of the inventors listed above which is a Continuation-In-Part (CIP) application of U.S. patent application entitled, “ELECTRONIC APPARATUS FOR HOSE ATTACHMENT TO ENHANCE VISIBILITY, COMMUNICATION, ATMOSPHERIC MONITORING, EARLY DETECTION AND WARNING FOR FIRE FIGHTER SCENE SAFETY AND METHOD THEREFOR”, Filed Oct. 31, 2012, and having U.S. Ser. No. 13/665,618 in the name of the James A. Mabry Jr. and Danny Kleitsch. This patent application further is related to U.S. Provisional Application No. 61/849,210, filed Jan. 22, 2013, entitled “KNOBGRIP™, CONVERTIBLE HANDLE FOR KNOBLITE™, ELECTRONIC APPARATUS FOR FIRE HOSE ATTACHMENT, TO ENHANCE HANDS-FREE FUNCTION, UTILITY, VISIBILITY, COMMUNICATION, ATMOSPHERIC MONITORING, AND SCENE SAFETY FOR FIRE FIGHTERS AND OTHER EMERGENCY RESPONDERS OPERATING IN THE HOT ZONE” in the name of James Mabry Jr., Danny Kleitsch, and Thomas Smith, and which is incorporated herein by reference in its entirety, and U.S. Provisional Application No. 61/957,954, filed Jul. 16, 2013, entitled “KNOBLITE™ UNIVERSAL, UNIVERSAL PLATFORM TO ENHANCE VISIBILITY, COMMUNICATION, ATMOSPHERIC METERING/MONITORING, PERSONAL METERING/MONITORING, GLOBAL POSITIONING, EARLY DETECTION AND WARNING FOR FIRST RESPONDER/FIRE FIGHTER SCENE SAFETY AND WORLDWIDE POPULATION PROTECTION” in the name of James Mabry Jr., Danny Kleitsch, and Thomas Smith, and which is incorporated herein by reference in its entirety. The present patent application claims the benefit under 35 U.S.C. §119(e).

### BACKGROUND

This invention generally relates to firefighting equipment and more particularly pertains to a new illuminated fire hose, fire engine, fire ladder truck, and individual fire fighter tool attachment for providing a portable, optional light source for a fire hose, fire engine, fire ladder truck, and individual fire fighter that illuminates a target or a pathway as well as provide video monitoring capability and sensors for indicating/monitoring current conditions and warning systems to alert fire fighters of hazardous conditions and assist in the location of lost or incapacitated fire fighters.

Today's fire fighters are asked to fill many roles and operate on diverse emergency scenes. These scenes include structural fire fighting, wild land fire fighting, vehicular accidents, technical rescues, hazardous material exposures, and emergency medical incidents. All of these incident scenes present unique and different challenges. One of the commonalities is the utilization by fire fighters of hand lines with various extinguishing agents on almost every scene. Fire fighters use these hand lines not only to extinguish fire, but to protect themselves and the citizens they are called to serve, at any scene day or night. Fire fighters are required to carry an inordinate number of hand tools to include personal flashlights, scene lighting, extrication tools, fire fighting tools, medical equipment, and radios. The complexity of the work environment and minimum staffing on most emergency scenes makes it virtually impossible for crews to be adequately prepared and carry all the tools they need for any one situation. The necessity to return to on scene fire vehicles to retrieve additional equipment is time consuming and dangerous. Fire fighters need a new option to lessen their work loads, enhance visibility, improve communication, identify unseen hazards, provide early warning, and make the operating environment a more efficient and safer place to work.

Therefore, it would be desirable to provide a device and method that overcomes the above problems. The device and method would provide a hands-free tool to assist fire crews involved in search, rescue, and fire suppression efforts. The device and method would provide a lighting source and video monitoring capability to be used in fire fighting operations that provides adequate lighting for engaged fire fighters and remote video monitoring capability by fire ground supervisors to promote safe operations inside or outside a structure. An example of inside operations would be a commercial structure fire, apartment fire, or house fire. An example of outside operations would be a wild land fire or illuminating the scene of a vehicle accident. The device and method would provide a high-intensity light source and video monitoring capability that may be affixed to any nozzle on a hand line of a fire hose, water discharge outlet of a fire engine/ladder truck, or individually carried by a fire fighter with a carrying device.

The device and method would provide for atmospheric monitoring to detect hazardous materials in the work environment. The device and method would provide for personal health monitoring of individual fire fighters to promote early treatment for sickness or injury. The device and method would act as an early warning device for structure collapse, self-contained breathing apparatus air management, or lost/incapacitated fire fighter. The device and method would provide these benefits and enhanced communication through a hands-free, voice free lighting system easily visible to the fire fighters on the face of the device with an integrated video monitoring capability able to provide real time video presentation to incident commanders at locations distant from the engaged fire fighters. Command units on the perimeter of the emergency scene would be constantly apprised of fire fighting operating conditions and could communicate instantly the necessity to change strategy, withdraw crews from dangerous situations, or effect a rescue.

### SUMMARY

A device for attachment to a fire hose, water discharge outlet on a fire engine/ladder truck, that enhances fire ground visibility by means of a lighting source, enhances fire ground communication by means of a video monitoring source, and enhances fire fighter safety by means of an atmospheric/biological metering/monitoring/warning source. All of the enhancements are contained in one, lightweight unit with the ability to be deployed anywhere on the fire scene.

An illumination device for attachment to a hose has a housing coupled to the hose. The housing allows a substance from the hose to flow through the housing. An electronic circuit is stored in an interior of the housing to illuminate an area in front of the hose and to transmit data to and from the illumination device.

An illumination device for attachment to a hose has a housing coupled to the hose. The housing allows a substance from the hose to flow through the housing. An electronic circuit is stored in an interior of the housing to illuminate an area in front of the hose, to transmit video and monitored data to and from the illumination device and monitor operating conditions approximate the illumination device.

The features, functions, and advantages may be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a first elevated perspective view of the light source device of the present invention;

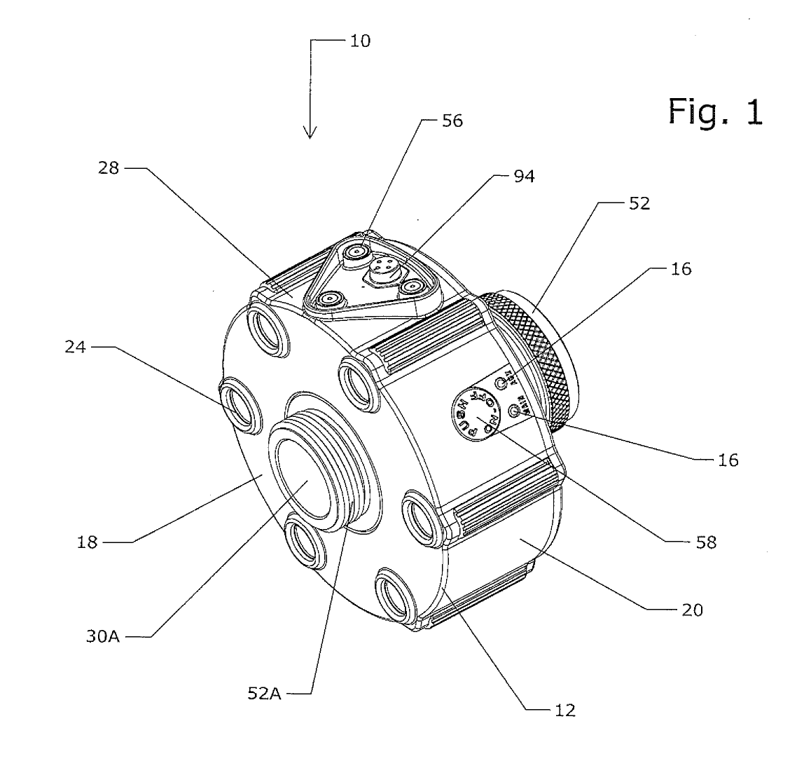

FIG. 2 is the first elevated perspective view of the light source device in accordance with FIG. 1 with a battery pack attached thereto;

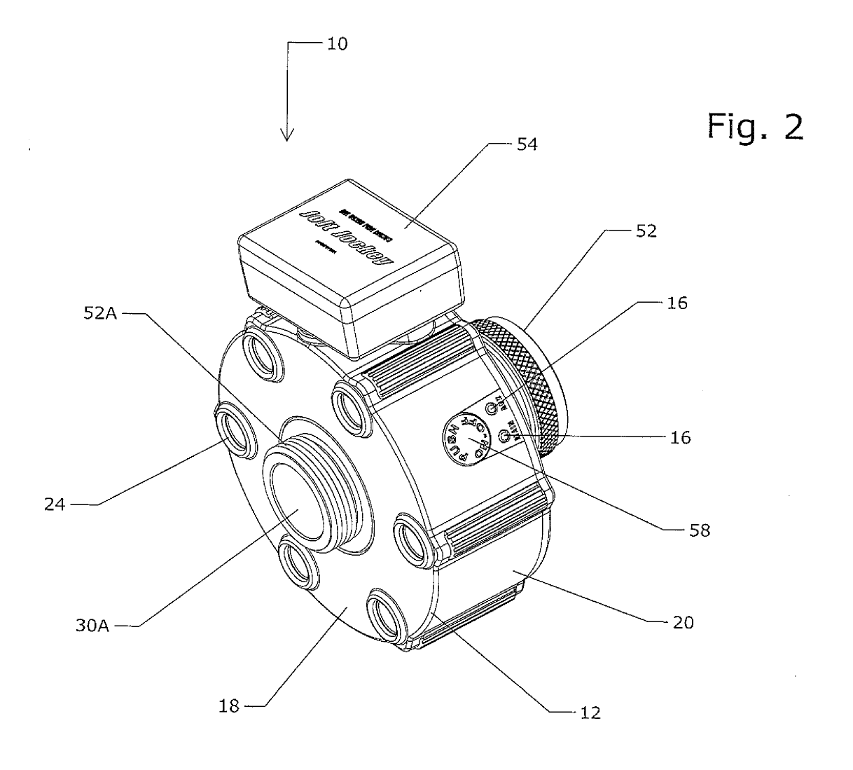

FIG. 3 is a second elevated perspective view of the light source device of the present invention;

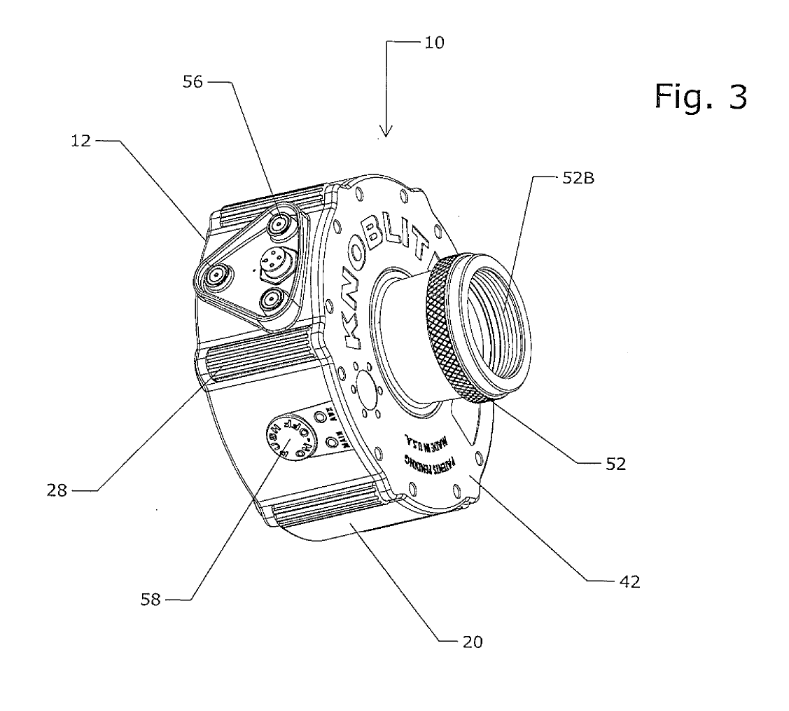

FIG. 4 is the second elevated perspective view of the light source device in accordance with FIG. 2 with the battery pack attached thereto;

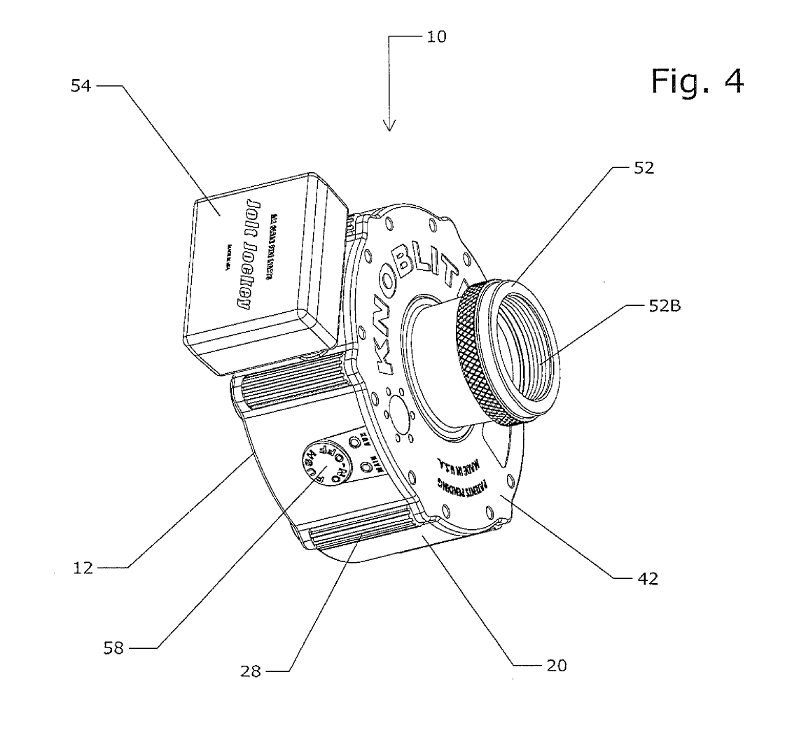

FIG. 5 is a first exploded side view of the light source device of the present invention;

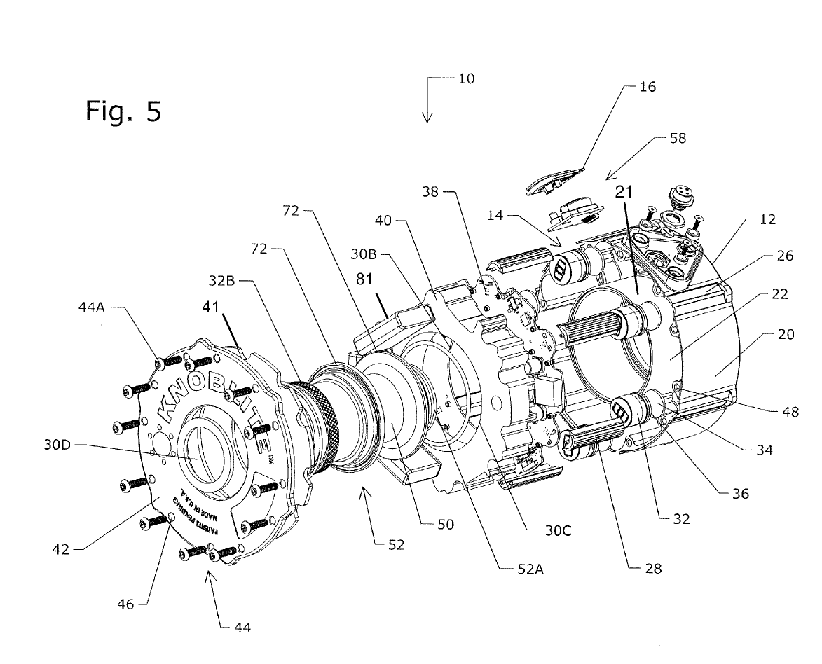

FIG. 6 is a first elevated perspective view of the light source device with a battery pack attached to a fire hose;

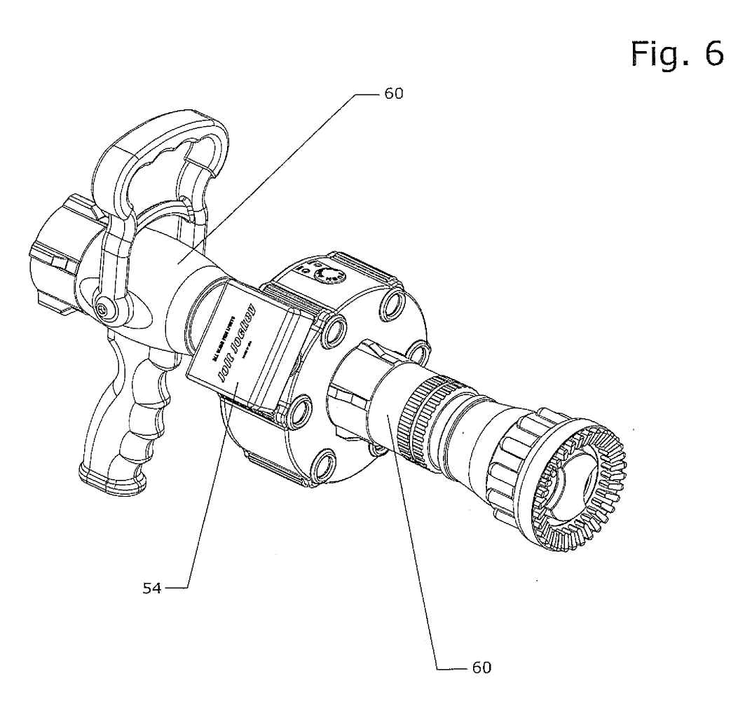

FIG. 7 is a second elevated perspective view of the light source device with a battery pack attached to a fire hose;

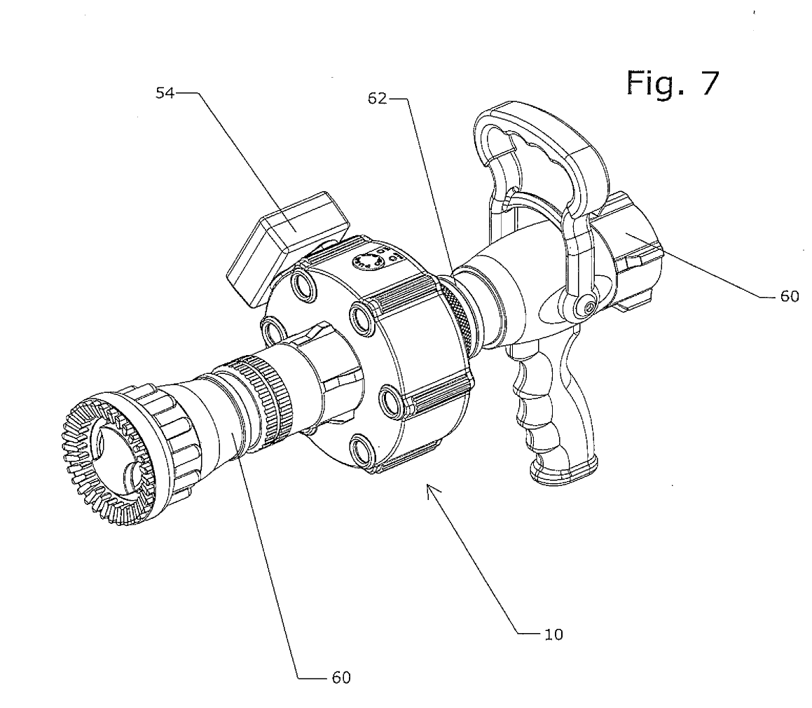

FIG. 8 is a side view of the light source device with a battery pack attached to a fire hose;

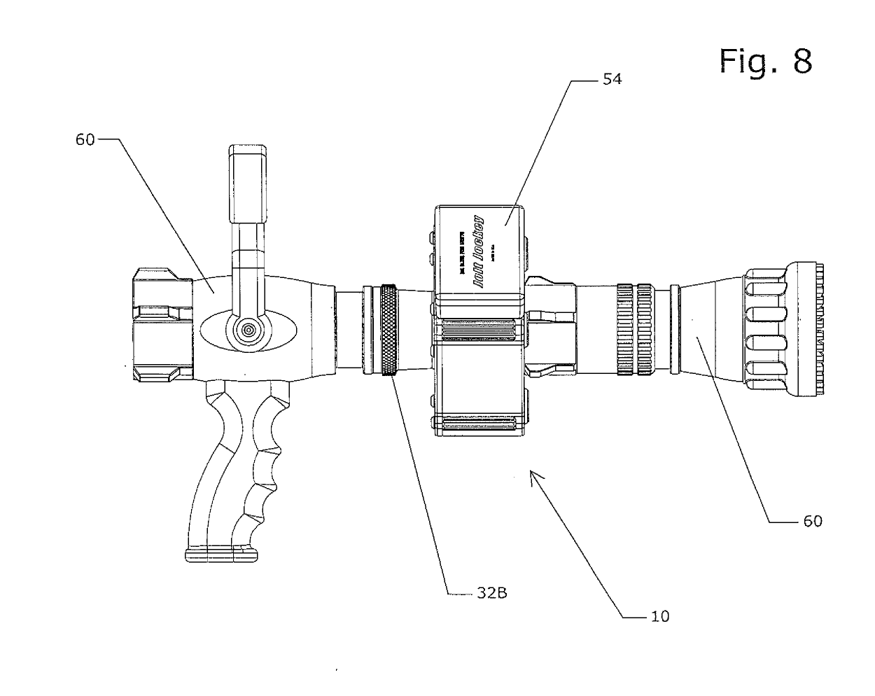

FIG. 9 is an exploded perspective view of the battery pack used with the light source device of the present invention;

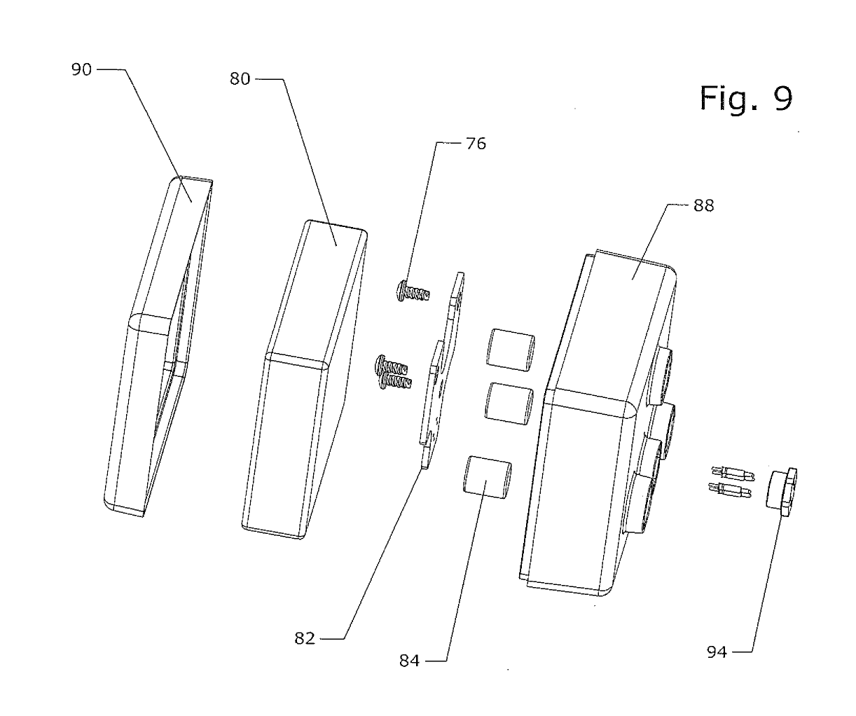

FIG. 10 is an elevated perspective view of the battery pack used with the light source device of the present invention attached to a charger;

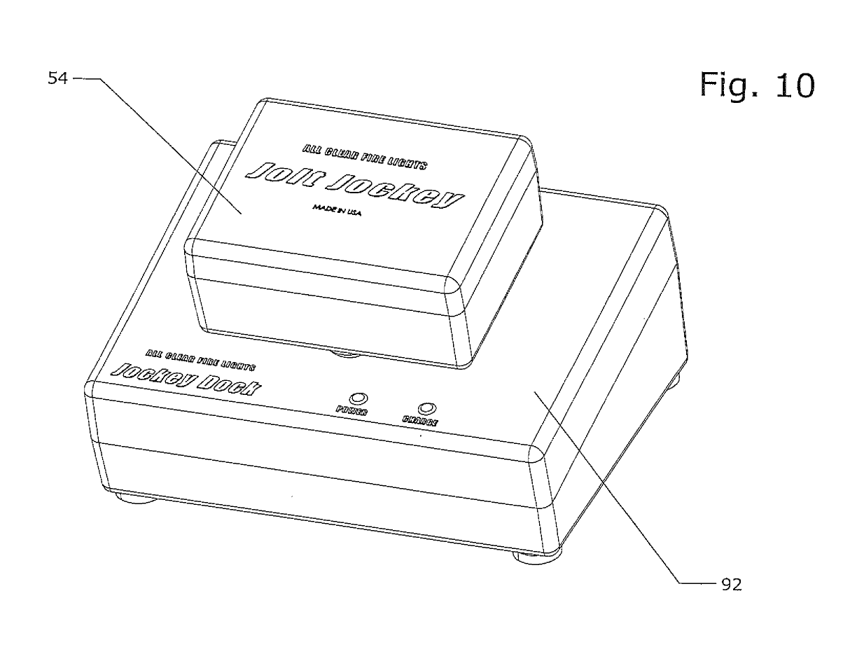

FIG. 11 is an elevated perspective view of the charger used with the battery pack;

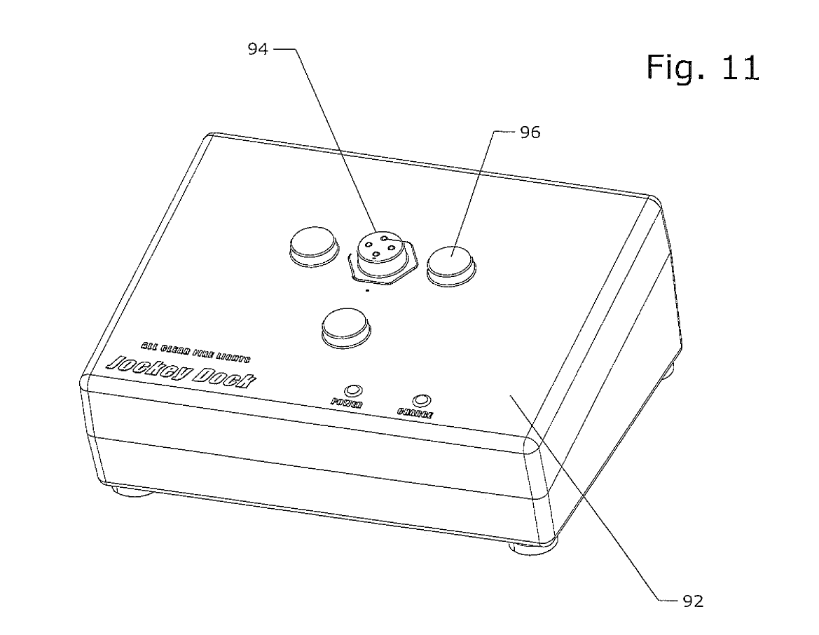

FIG. 12 is a block diagram of the electronic circuit used in the present invention; and

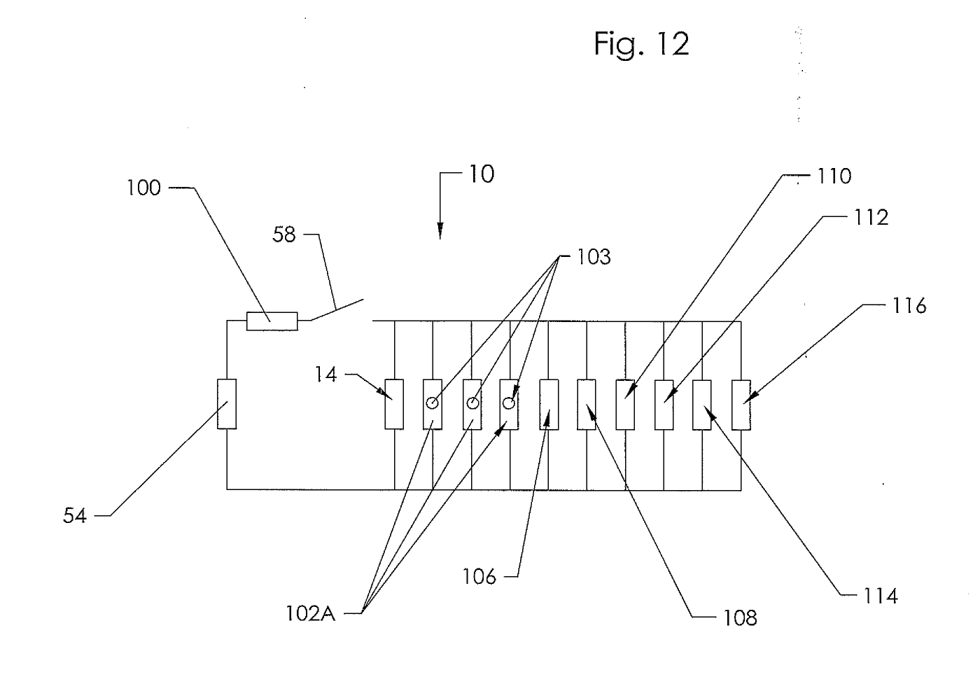

FIG. 13 is a perspective view of the light source device of the present invention attached to a fire engine water gun.

### DETAILED DESCRIPTION

Referring to the Figures, a light source device (hereinafter device 10) of the present invention is shown. The device 10 may be attached to any fire hose/nozzle, water discharge outlet on a fire engine/ladder truck or carried by an individual fire fighter by means of a lifting and carrying device as will be described below. The device 10 may provide future generations of fire fighters with a means that attaches to fire nozzles and fire hose couplings that may allow fire fighters to advance hose lines into structure fires, wild land fires, vehicle fires, hazardous material environments, and other hazardous situations without the necessity of these fire fighters assuming the burden of carrying hand held flashlights on their person. The device 10 may further provide video monitoring capability for incident commanders at remote locations on the fire scene to evaluate the work efforts and conditions being experienced by fire fighters engaged in fire fighting operations. The device 10 may further provide visual indicators about current operating conditions for the firefighters as will be discussed below.

The device 10 may be configured to securely fit between a fire nozzle 60 and fire hose coupling 62. Alternatively, the device 10 may be positioned between two fire hose couplings 62. Additionally, the device 10 may be attached to a water discharge outlet on a fire engine/ladder truck. The device 10 is designed to not impede the flow of extinguishing agent or to be obstructive when moved around the fire ground when the device 10 is positioned between the fire nozzle 60 and fire hose coupling 62 or between two fire hose couplings 62. Likewise, the device 10 will not impede the flow of extinguishing agent when attached to a water discharge outlet on a fire engine/ladder truck.

The device 10 may have a housing 12. The housing may be used to store and house a plurality of lighting fixtures 14. The lighting fixtures 14 may be used to illuminate the fire ground and guide the fire fighter as he/she advances the hose lines. The housing 12 may further be used to store and house one or more visual indicators 16. The visual indicators 16 may be used to provide warnings to the firefighters about current operating conditions. The housing 12 may be constructed of a material that is lightweight, durable, heat resistant, cold resistant, water resistant, and able to function flawlessly in the demanding environments occupied by fire fighters in the course of their work.

The housing 12 may be formed of different geometric shapes. In the present embodiment, the housing 12 is circular in shape. A circular shape housing 12 may provide the least amount of resistance when moving the fire hose with the device 10 attached. However, the circular shape is shown as one embodiment, and should not be seen in a limiting manner.

The housing 12 may be comprised of a front plate 18. A side wall 20 may be formed around a perimeter of the front plate 18. The side wall 20 may be formed to extend up from the front plate 18 there by forming a hollow interior section 22 of the housing 12. The interior section 22 may be used to store and house the plurality of lighting fixtures 14 as well as electronics for one or more visual indicators 16.

One or more openings 24 may be formed through the front plate 18. The openings 24 may be formed around the perimeter of the front plate 18. The openings 24 may be used to position the one or more lighting fixtures 14 within the housing 12. One or more slots 26 may also be formed within the side wall 20. The one or more slots 26 may be formed next to and adjacent a corresponding opening 24. The slots 26 may be used to allow easy removal of a corresponding lighting fixture 14. A fixture plate 28 may be positioned within each slot 26 to secure the lighting fixture 14 within the slot 26 and corresponding opening 24. The fixture plate 28 may be designed to be pressure fitted within the slots 26. Thus, by applying pressure to the fixture plate 28, one may be able to release the fixture plate 28 from within the slots 26, thereby allowing one to remove the corresponding lighting fixture 14.

The plurality of lighting fixtures 14 may be positioned around an outer perimeter of the housing 12. This may allow the lighting fixtures 14 to be directed to illuminate the extinguishing agent exiting the device 10. This may help firefighters determine if the extinguishing agent exiting the device 10 is being properly directed in the right area/location to extinguish the fire. Under conditions where the refractive index of the illuminated stream is higher than that of the surrounding environment, water flowing through air, for example, the fluid stream captures and contains the light much as an optical fiber does, permitting the light to flow with the stream, through clouds of particulates and combustion gases without suffering the high degree of scattering that would otherwise occur. This illuminated fluid can facilitate easier application with water/foam in limited visibility environments on the fire scene. The UV components of the light emitted by the lighting fixtures 14 are also of utility in illuminating the scene without back scattering (glare) in the visible spectrum. UV light emitted does scatter in the smoke, but such scatter is invisible to the human eye such that fluorescent and phosphorescent objects within the smoke-filled environment, including reflective sections on fire fighters' turnout gear, provide visual cues and references to the fire fighter.

As stated above, a plurality of lighting fixtures 14 may be positioned within the housing 12. As shown in the Figures, each lighting fixture 14 may be comprised of a light source unit 32. Each light source unit 32 may be a high-intensity, LED lighting fixture that may be able to illuminate the fire ground and guide the fire fighter as he/she advances hose lines. A lens 34 may be positioned in front of each light source unit 32. The lens 34 may be used to focus and/or direct the light from the light source unit 32. The lens 34 may also be used to protect the light source unit 32. A lens housing 36 may be used to secure the lens 34 in front of each light source unit 32. A plate member 38 may be used to secure the lighting fixture 14 within the interior section 22 of the housing 12.

The housing 12 may have a cover 40. The cover 40 may be positioned over the interior section 22 of the housing 12. Thus, the cover 40 may be used to enclose the housing 12. A locking plate 42 may be used to secure the cover 40 to the housing 12. The locking plate 42 may have one or more securing members 44. The securing members 44 may be used to secure the cover 40 to the housing 12. In accordance with one embodiment, the securing members 44 may be a plurality of screws 44A. As shown in the Figures, one or more openings 46 may be formed around an outer perimeter of the locking plate 42. Each opening 46 may be aligned with a corresponding channel 48 formed on the housing 12. Each channel 48 may be formed on the side wall 20. Each channel 48 may be threaded so as to engage a corresponding screw 44A.

The front plate 18, the plate member 38, the cover 40, and locking plate 42 may each have a central opening 30A, 30B, 30C and 30D respectively, formed there through. The central openings 30A, 30B, 30C and 30D may be used to allow the extinguishing agent to enter and flow through the housing 12.

A pipe 50 may be positioned through the housing 12. The pipe 50 may be used to allow the extinguishing agent to pass through the housing 12. In accordance with the embodiment depicted in the Figures, the pipe 50 may be positioned through the central openings 30A, 30B, 30C and 30D formed through the front plate 18, the plate member 38, the cover 40, and locking plate 42 respectively. The pipe 50 may be used to allow the extinguishing agent to enter and flow through the housing 12.

The pipe 50 is designed to not impede the flow of extinguishing agent or to be obstructive when moved around the fire ground when the device 10 is positioned between the fire nozzle 60 and fire hose coupling 62 or between two fire hose couplings 62. The pipe 50 may have a coupling 52 located on each end. The coupling 52 may be used to connect the pipe 50 between the fire nozzle 60 and fire hose coupling 62 or between two fire hose couplings 62. The coupling 52 may be a threaded end 52A, a threaded hose coupling 52B, or the like. The above is given as an example and should not be seen in a limiting manner. Other couplings may be used without departing from the spirit and scope of the present invention.

The pipe 50 may further have a pair of ring members 72. A ring member 72 may be positioned on each end of the pipe 50. The ring members 72 may be used to secure the pipe 50 within the housing 12.

The housing 12 may have one or more contacts 56. The contacts 56 may be used to secure a power supply 54 to the housing 12. The power supply 54 may be used to power electronic circuitry 70 stored within the housing 12. The power supply 54 is interchangeable so that a current power supply 54 may be removed, and a fully charged power supply attached to the contacts 56. The power supply 54 may also be a rechargeable power supply.

The Figures show one embodiment of the power supply 54. As may be seen in the Figures, the power supply 54 may have a battery unit 80. The battery unit 80 may be used to supply a DC power source to the electronic circuitry 70. The battery unit 80 may have a contact board 82 attached thereto. One or more securing devices 76 may be used to secure the contact board 82 to the battery unit 80. The contact board 82 may be used to attach a battery contact 84 to the battery unit 80. The battery contact 84 may be used to attach the power supply 54 to contacts 56. This may allow the power supply 54 to attach to the electronic circuitry 70. When in use, the battery contact 84 may contact the contacts 56 to secure the power supply 54 to the housing 12 and to the electronic circuitry 70.

The battery unit 80 may be stored within a battery housing 88. A lid 90 may be attached to the battery housing 88 thereby enclosing the battery unit 80 within the battery housing 88.

In accordance with one embodiment, the battery unit 80 is a rechargeable battery unit. One or more charging pins 92 may be coupled to one of the battery contacts 84. This may allow the charging pins to attach to a charging plug 94 of a recharging unit 92. One or more alignment pins 90 may be formed on the battery housing 88. The alignment pins 90 may be used to align the power supply 54 onto a recharging unit 92 having corresponding alignment pins 96.

The housing 12 may store electronic circuitry 70. The electronic circuitry 70 may be positioned within the interior section 22 of the housing 12. The electronic circuitry 70 may be capable of connecting and operating a myriad of simple systems that perform functions essential to fire fighter safety.

A switch 58 may be coupled to the power supply 54. The switch 58 may be used to activate and deactivate the electronic circuitry 70. The switch 58 may be located on the exterior of the housing 12. The switch 58 may be programmed to “turn on” with a 0.5 second engagement and “turned off” with a 3.0 second engagement to avoid any inadvertent termination of the electronic circuitry 70 during operation. The switch 58 may further double as a “CAP” (conditions, air, people) elapsed time warning light. Fire fighters are taught that 10 minutes of flame impingement on building structural components seriously effect construction integrity and pose serious collapse hazards to fire fighters inside structure. The switch 58 may be an illuminating switch. When activated, the switch 58 may automatically initiate a timer 100. The switch 58 may appear “green” advising fire fighters that they have been inside the “hot zone” for less than 10 minutes. At 10 minutes the switch 54 will begin blinking “red”. This will remind fire fighters to address their tactical priorities:
(1) Conditions: re-evaluate the interior conditions of the structure for safety.
(2) Air: check the available air in you and your crew's SCBA bottles.
(3) People: know the location and condition of all your assigned members.
   and begin to plan their egress from the structure. At 15 minutes the blinking “red” will become a solid “red”. This will provide a “fire fighter off line/MAYDAY” safety feature that will keep the device illuminated to act as a beacon for fire fighters attempting to find the hand line in low visibility environments or locate lost/incapacitated fire fighters. The light function on the switch 56 can again be illuminated by engaging the switch 58 for 0.5 second.

One of the functions of the electronic circuitry 70 may be to provide a high-intensity, LED lighting system able to illuminate the fire ground and guide the fire fighter as he/she advances hose lines. Thus, the lighting fixtures 14 are generally coupled to the power supply 54. The lighting fixtures 14 may be programmed to automatically turn off at 15 minutes to save on the life of the power supply 54 should the nozzle be unattended and acts as a timer for work cycles. Whether inside a structure, outside on a wild land fire, or on the scene of an auto accident the lighting fixtures 14 may have a minimum of two settings, high/low. The choice of light intensity will not affect the light timing as it is independent of the fire fighter choice of light intensity. Timing requirements can be altered or customized per individual fire department specifications and needs.

One or more sensors/alarms 102 may also be coupled to the power supply 54. One of the sensors/alarms 102 may be for example a hazmat monitor 102A. The hazmat monitor 102A may monitor for hazardous materials such as O₂, CO, SO₂, CN, radiation, LEL (explosion limit), and the like. The listing of the above is given as an example and should not be seen in a limiting manner. The hazmat monitor 102A may be coupled to a visual indicator 103 Thus, when hazmat monitor 102A detects a specified hazardous material, the corresponding visual indicator 103 may illuminate. The above listed sensors/alarms 102 and hazmat monitors 102A are only given as examples and should not be seen in a limiting manner. Other types of meters, atmospheric/biological monitors, and safety warning devices that enhance scene safety and fire fighter survivability may be incorporated without departing from the spirit and scope of the present invention.

The electronic circuitry 70 may further have a receiver/transmitter unit 106. The receiver/transmitter unit 106 may be used to transmit video/data collected from the electronic circuitry 70 to a desired location (i.e., command post, etc.). The receiver/transmitter unit 106 may further be used to receive video/data transmitted by another party. For example, the receiver/transmitter unit 106 may receive a command to evacuate the building transmitted by the command post. In this situation, the receiver/transmitter unit 106 may cause the electronic circuitry 70 to start flashing all visual indicators 103.

The receiver/transmitter unit 66 may further be able to receive and then transmit current health data of the firefighter. For example, a firefighter may wear one or more sensors to monitor the firefighter's health (i.e., heart rate, blood pressure, O₂ levels, etc. The information monitored by these sensors may then be collected and transmitted by the receiver/transmitter unit 106 to a desired location (i.e., command post, etc.).

The electronic circuitry 70 may further have a display screen 108. The display screen 108 may be used to display graphical information. For example, the display screen 108 may display information captured by the sensors 102 and or sensors on the firefighters as discussed above. The display screen 108 may display information transmitted by the command post. The above is given as examples of information that may be displayed on the display screen 108. Other information may be displayed without departing from the spirit and scope of the present invention. It should also be noted that the display screen 108 may be used for other purposes than that described above without departing from the spirit and scope of the present invention.

The electronic circuitry 70 may further have a distress button 110. The distress button 110 when activated would alert others that a firefighter is in need of help. The distress button 110 may send a signal which causes all of the lighting fixtures 14 to start flashing. The distress button 110 may send a signal to the receiver/transmitter unit 106 which may transmit a signal to a command post that the firefighter is in trouble. The above are given as examples. The distress button 110 when activated may alert others that a firefighter is in need of help in other ways without departing from the spirit and scope of the present invention.

The device 10 may have one or more video cameras 112. The video camera 112 may be able to provide streaming video, still photographs, or a combination of the aforementioned. The video camera 112 may further have audio capability to record audio signals around the device 10. The video camera 112 may be mounted to a lighting fixture 14. Alternatively, the video camera 112 may be mounted on other areas of the device 10. The video camera 112 should be mounted on the device 10 to have an unobstructed view.

Because of the enhanced lighting feature of the device 10, the video camera 112 may be able to record the actions of and conditions experienced by fire fighters engaged in fire fighting operations. The video camera 112 may be coupled to the receiver/transmitter unit 106. This may allow one to transmit audio/video data captured by the video camera 112 to a desired location (i.e., command post, etc.). The transmitted audio/video data may then be used by emergency scene supervisors/trainers/educators to evaluate and recommend behavior conducive to enhanced scene safety and fire fighter survivability.

The device 10 may further have a locating device 114. The locating device 114 may be positioned within the housing 12. The locating device 114 may be coupled to the receiver/transmitter unit 106. The locating device 114 may send signals via the receiver/transmitter unit 106 to indicate a present location of the device 10. Thus, a fire fighter's position may be tracked and monitored by emergency scene supervisors/trainers/educators to enhanced scene safety and fire fighter survivability.

The device 10 may further have a communication module 116. The communication module 116 may allow the fire fighters to communicate with emergency scene supervisors/trainers/educators. The communication module 116 may be coupled to the receiver/transmitter unit 106. The receiver/transmitter unit 106 may allow audio signals to be transmitted to and from the device 10. In accordance with one embodiment, the communication module 116 may have an audio port. The audio port may allow one to connect a headset to the device to allow one to transmit and receive audio signals from the headset.

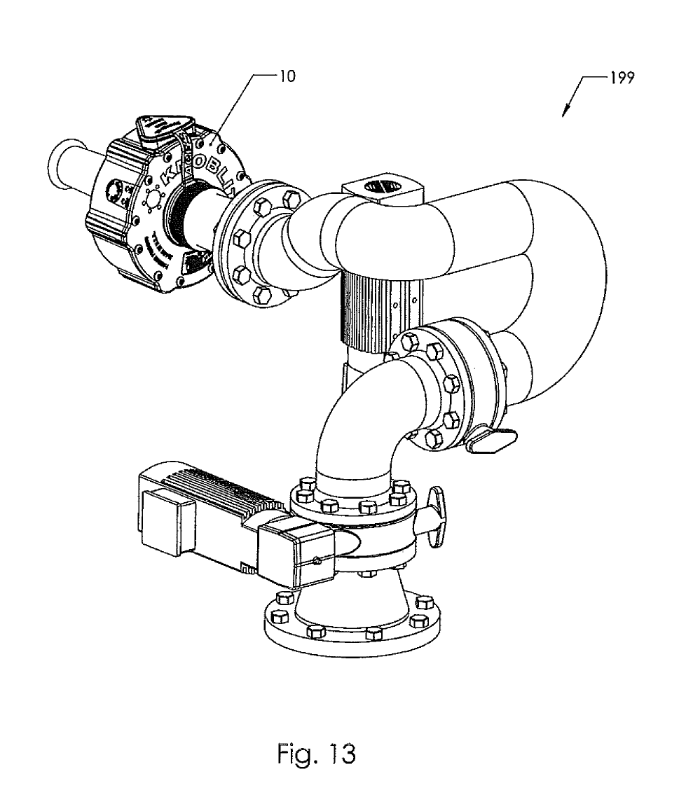

The device 10 may be mounted on other items beside a fire nozzle 60 and fire hose coupling 62. Referring now to FIG. 13, the device 10 is shown coupled to a fire engine water cannon 199. As stated above, since the plurality of lighting and video fixtures 14 are positioned around an outer perimeter of the housing 12, the lighting and video fixtures 14 may be directed to illuminate the extinguishing agent exiting the device 10. This helps firefighters determine if the extinguishing agent exiting the device 10 is being properly directed in the right area/location to extinguish the fire. Under conditions where the refractive index of the illuminated stream is higher than that of the surrounding environment, water flowing through air, for example, the fluid stream captures and contains the light much as an optical fiber does, permitting the light to flow with the stream, through clouds of particulates and combustion gases without suffering the high degree of scattering that would otherwise occur. This illuminated fluid can facilitate easier application with water/foam in limited visibility environments on the fire scene. The UV components of the light emitted by the lighting and video fixtures 14 are also of utility in illuminating the scene without back scattering (glare) in the visible spectrum. UV light emitted does scatter in the smoke, but such scatter is invisible to the human eye such that fluorescent and phosphorescent objects within the smoke-filled environment, including reflective sections on fire fighters' turnout gear, provide visual cues and references to the fire fighter.

While embodiments of the disclosure have been described in terms of various specific embodiments, those skilled in the art will recognize that the embodiments of the disclosure may be practiced with modifications within the spirit and scope of the claims.

1. An illumination device comprising:
a housing having a housing interior formed by substantially flat front plate, an inner perimeter wall and an outer perimeter wall, the front plate having a plurality of light unit openings at the outer perimeter wall, the inner perimeter wall aligned with a fluid flow path originating from a center opening in the housing;
a plurality of high intensity light source units respectfully positioned in the plurality of light unit openings to emit light forward from the front plate including a portion of the emitted light at an angle intersecting with the fluid flow path forward from the front plate;
an electronic circuit including the plurality of high intensity light source units coupled to a battery stored in an interior of the housing to power and illuminate an area forward of the front plate;
a cover with a perimeter shape to fit against the inner perimeter wall and outer perimeter wall and a depth at least as great as the battery, the cover enclosing the plurality of light sources in the housing interior and isolating the battery from the plurality of light sources; and
a housing back plate attachable to the exterior side wall to seal the housing interior.

2. An illumination device in accordance with claim 1, wherein the plurality of light unit openings each have light unit opening perimeters and a portion of each light unit opening perimeter is coincident with a portion of the outer perimeter wall.

3. An illumination device for in accordance with claim 1, wherein the cover is a two-piece cover having a first piece and a second piece, the first piece with an exterior perimeter shape to fit within and match the housing interior shape and a thickness at least as great as the battery, the first piece over the plurality of light sources in the housing interior and isolating the battery, the second piece positioned against the first piece sealing the battery within the two-piece cover.

4. An illumination device in accordance with claim 3, wherein the front plate is substantially circular and the diameter of the front plate is at least one and a half times larger than the diameter of the center opening.

5. An illumination device in accordance with claim 4, wherein the diameter of the front plate is less than five times larger than the diameter of the center opening.

6. An illumination device in accordance with claim 2, wherein
the plurality of light unit openings are distributed evenly around the front plate and the plurality of lighting units each include a high intensity LED adjacently rearward of a focusing lens, wherein the lighting units direct a portion of emitted light with sufficient energy to intersect with the flow path and illuminate a stream of extinguishing agent exiting the central opening of the illumination device.

7. An illumination device in accordance with claim 6, wherein the electronic circuit further comprises:
a timer coupled to the power supply; and
an on/off switch coupled to the timer and the power supply, the on/off switch activating and deactivating the electronic circuit, wherein the on/off switch illuminates for a predetermined amount of time based on the timer.

8. An illumination device in accordance with claim 6, wherein the electronic circuit further comprises at least one monitor coupled to the power supply, wherein the at least one monitor measures air quality.

9. An illumination device in accordance with claim 6, wherein the electronic circuit further comprises a display coupled to the power supply.

10. An illumination device in accordance with claim 1, further comprising
a stream of liquid extinguishing agent coupled to the housing at the inner perimeter wall, the liquid extinguishing agent having a higher refractive index than air and expelled through the housing along the fluid flow path wherein light from the plurality of high intensity light source units reflects upon and refracts within and illuminates the stream of liquid extinguishing agent.

11. (canceled)

12. (canceled)

13. An illumination device in accordance with claim 1, further comprising a pipe positioned through the housing.

14. An illumination device in accordance with claim 13, further comprising a coupling attached on each end of the pipe to secure one of a hose or a nozzle on each end of the pipe.

15. An illumination device in accordance with claim 6, wherein the power supply is removably attached to an exterior of the housing.

16. An illumination device, comprising:
a housing having a substantially flat front plate with an inner perimeter wall and an outer perimeter wall, a plurality of circular light unit openings in the front plate and aligned with the outer perimeter wall to emit light forward from the front plate, wherein the housing allows a substance to flow through the housing;
a plurality of lenses respectively rearward of the plurality of circular light unit openings, each lens focusing a portion of the light from one of a plurality of LED lighting units to intersect with a fluid flow path from the housing;
an electronic circuit including a battery stored inside the housing to power the plurality of LED lighting units that illuminate an area in front of the front plate; and
a cover extending from the inner perimeter wall to the outer perimeter wall with a depth at least as great as the battery, the cover positioned between the battery and the plurality of LED lighting units.

17. An illumination device in accordance with claim 16, wherein the cover comprises a first piece and a second piece, the first piece positioned between the battery and the plurality of LED lighting units and the second piece positioned between the battery and a locking plate to secure the second piece against the first piece within the housing.

18. An illumination device in accordance with claim 16, wherein the plurality of circular light unit openings are have a combined surface area of between five and twenty percent of the front plate surface area and each light unit opening is positioned opposite another light unit opening.

19. An illumination device in accordance with claim 16, wherein the electronic circuit comprises:
a transmitter/receiver coupled to the power supply for transmitting and receiving data to and from the electronic circuit.

20. An illumination device in accordance with claim 19, wherein the electronic circuit further comprises at least one monitor coupled to the power supply, wherein the at least one monitor measures air quality.
